(19) United States
(12) Patent Application Publication
(10) Pub. No.: US 2023/0084812 A1
(43) Pub. Date: Mar. 16, 2023

(54) PIGMENT DISPERSION FOR INKJET INK AND INKJET INK

(71) Applicant: KYOCERA Document Solutions Inc., Osaka (JP)

(72) Inventor: Sayaka KITAGAWA, Osaka-shi (JP)

(73) Assignee: KYOCERA Document Solutions Inc., Osaka (JP)

(21) Appl. No.: 17/822,377

(22) Filed: Aug. 25, 2022

(30) Foreign Application Priority Data
Aug. 27, 2021 (JP) 2021-138861

(51) Int. Cl. C09D 11/324; C09D 11/033; C09D 11/037; C09D 11/107; C09D 17/00

(52) U.S. Cl. CPC C09D 11/324; C09D 11/033; C09D 11/037; C09D 11/107; C09D 17/001

(57) ABSTRACT

A pigment dispersion for an inkjet ink contains pigment particles, styrene-acrylic resin, and water. The styrene-acrylic resin includes a first repeating unit having a group represented by formula (1) and a second repeating unit not having a repeating unit represented by formula (1).

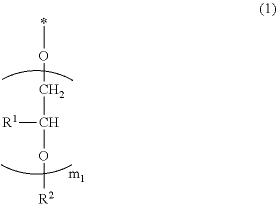

The first repeating unit has a percentage content to the total mass of the first repeating unit and the second repeating unit of at least 1% by mass and no greater than 10% by mass. In formula (1), R¹ represents a hydrogen atom or a methyl group, R² represents a hydrogen atom or an alkyl group with a carbon number of at least 1 and no greater than 7, and m₁ represents an integer of at least 4 and no greater than 9.

### INCORPORATION BY REFERENCE

The present application claims priority under 35 U.S.C. § 119 to Japanese Patent Application No. 2021-138861, filed on Aug. 27, 2021. The contents of this application are incorporated herein by reference in their entirety.

### BACKGROUND

The present disclosure relates to a pigment dispersion for an inkjet ink and an inkjet ink.

An image is formed on a recording medium by ejecting an inkjet ink from a recording head of an inkjet recording apparatus. There is a demand for high preservation stability of the inkjet ink and a pigment dispersion contained therein so that qualities thereof are maintained even under storage for a long period of time. For example, an aqueous pigment dispersion is known that contains at least a pigment (A), an anionic group-containing organic polymer compound (B), and a copolymer (C) of (meth)acrylic acid, (meth)acrylate, and acrylate having a polyoxyethylene group with a straight chain or branched chain alkyl group with a carbon number of at least 18 and no greater than 22 located at the end of the polyoxyethylene group. The mass ratio (C/A) between the copolymer (C) and the pigment (A) is in a range of from 1/1000 to 7/100.

### SUMMARY

A pigment dispersion for an inkjet ink according to an aspect of the present disclosure contains pigment particles, styrene-acrylic resin, and water. The styrene-acrylic resin includes a first repeating unit having a group represented by formula (1) and a second repeating unit not having a repeating unit represented by the formula (1). The first repeating unit has a percentage content to a total mass of the first repeating unit and the second repeating unit of at least 1% by mass and no greater than 10% by mass.

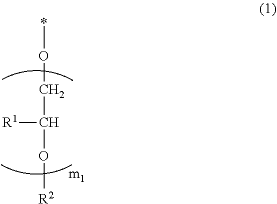

In the formula (1), R¹ represents a hydrogen atom or a methyl group, R² represents a hydrogen atom or an alkyl group with a carbon number of at least 1 and no greater than 7, and m₁ represents an integer of at least 4 and no greater than 9.

An inkjet ink according to another aspect of the present disclosure contains the above pigment dispersion and a water-soluble organic solvent.

### DETAILED DESCRIPTION

The following describes embodiments of the present disclosure. In the following description, the term “-based” may be appended to the name of a chemical compound to form a generic name encompassing both the chemical compound itself and derivatives thereof. Also, when the term “-based” is appended to the name of a chemical compound used in the name of a polymer, the term indicates that a repeating unit of the polymer originates from the chemical compound or a derivative thereof. Unless otherwise stated, the number average primary particle diameter of a measurement target is a number average value of equivalent circle diameters (Heywood diameters: diameters of circles having the same areas as projected areas of primary particles) of 100 primary particles of the measurement target as measured using a scanning electron microscope (product of JEOL, Ltd. “JSM-7401F)” and image analysis software (product of MITANI CORPORATION, “WinROOF”). The DBP oil absorption is a value as measured by a method in accordance with ISO 4656:2012 unless otherwise stated. The BET specific surface area of pigment particles is a value as measured by a method in accordance with ISO 4652:2012 unless otherwise stated. The viscosity is a value as measured by a method in accordance with the method prescribed in the Japanese Industrial Standards (JIS) Z 8803:2011 Methods for viscosity measurement of liquid” in an environment at 25° C. unless otherwise stated. The term “(meth)acryl” is used as a generic term for both acryl and methacryl. The term “(meth)acrylonitrile” is used as a generic term for both acrylonitrile and methacrylonitrile. Any one type of each component described in the present specification may be used independently, or any two or more types of the component may be used in combination.

### First Embodiment: Pigment Dispersion for Inkjet Ink

The first embodiment of the present disclosure relates to a pigment dispersion for an inkjet ink. In the following, the “pigment dispersion for an inkjet ink” may be referred to as “pigment dispersion” and the “inkjet ink” may be referred to as “ink”. The pigment dispersion of the first embodiment contains pigment particles, styrene-acrylic resin, and water. The pigment dispersion of the first embodiment is an aqueous pigment dispersion containing water.

(Styrene-Acrylic Resin)

The styrene-acrylic resin includes a first repeating unit and a second repeating unit. The first repeating unit has a group represented by formula (1). The second repeating unit does not have a group represented by formula (1). The first repeating unit has a percentage content to the total mass of the first repeating unit and the second repeating unit of at least 1% by mass and no greater than 10% by mass. In the following, the “percentage content of the first repeating unit to the total mass of the first repeating unit and the second repeating unit” may be referred to as “first-repeating-unit percentage”. Also, the “styrene-acrylic resin having the first repeating unit having a group represented by formula (1) and the second repeating unit not having a group represented by formula (1) with a first-repeating-unit percentage of at least 1% by mass and no greater than 10% by mass” may be referred to as “specific styrene-acrylic resin”.

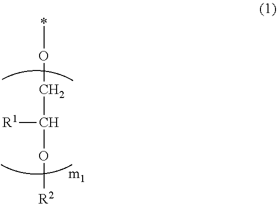

In formula (1), R¹ represents a hydrogen atom or a methyl group. R² represents a hydrogen atom or an alkyl group with a carbon number of at least 1 and no greater than 7. m₁ represents an integer of at least 4 and no greater than 9. * represents a bond, and specifically a bond that bonds to an atom (e.g., a carbon atom) constituting the first repeating unit.

The specific styrene-acrylic resin functions as a dispersant for dispersing the pigment particles in the pigment dispersion. As a result of the pigment dispersion containing the specific styrene-acrylic resin, the degree of dispersion of the pigment particles in the pigment dispersion tends to be controlled so that the pigment particles have a desired particle size distribution in terms of volume (also referred to below as volume particle size distribution). In the volume particle size distribution, pigment particles on a small particle diameter side tend to have higher chromaticity (e.g., black chromaticity where the pigment particles are carbon black) than pigment particles on a large particle diameter side. When the pigment dispersion contains the specific styrene-acrylic resin, the number of pigment particles on the large particle diameter side in the volume particle size distribution is moderately large. The pigment particles on the large particle diameter side fill gaps among fibers of a recording medium. As a result of the gaps being filled, the pigment particles with high chromaticity on the small particle diameter side hardly enter into the recording medium. The pigment particles with high chromaticity on the small particle diameter side stay on the surface of the recording medium to enable formation of images with desired image density with an ink containing the pigment dispersion. By contrast, when the pigment dispersion contains the specific styrene-acrylic resin, the number of pigment particles on the large particle diameter side in the volume particle size distribution is not excessively large. Therefore, preservation stability of the pigment dispersion increases and the ink containing the pigment dispersion can be stably ejected from a recording head. Effects of ejection stability of the ink from the recording head is particularly significant in intermittent printing which tends to cause ink drying and sticking in the nozzles of the recording head.

The specific styrene-acrylic resin is attached to the surfaces of the pigment particles to disperse the pigment particles in the pigment dispersion. In order to favorably disperse the pigment particles, it is preferable that the specific styrene-acrylic resin is directly attached to the surfaces of the pigment particles. In order to favorably disperse the pigment particles, it is also preferable that the specific styrene-acrylic resin covers the surfaces of the pigment particles in the ink. It is sufficient that at least a portion of the specific styrene-acrylic resin is attached to the surfaces of the pigment particles, and another portion of the specific styrene-acrylic resin may be free in the pigment dispersion without being attached to the surfaces of pigment particles.

The first repeating unit will be described next. The first repeating unit has a group represented by formula (1) as described previously. If R¹ in formula (1) represents a hydrogen atom, the group represented by formula (1) is a group derived from polyethylene glycol. Where R¹ represents a methyl group, the group represented by formula (1) is a group derived from polypropylene glycol.

As described previously, R² represents a hydrogen atom or an alkyl group with a carbon number of at least 1 and no greater than 7. Where R² represents a long-chain group such as an alkyl group with a carbon number of at least 8, the styrene-acrylic resin has high hydrophobicity and high molecular weight to be prone to increase the diameter of the pigment particles and increase viscosity of the pigment dispersion containing the styrene-acrylic resin. As a result of R² representing a hydrogen atom or an alkyl group with a carbon number of at least 1 and no greater than 7, the viscosity of the pigment dispersion containing the specific styrene-acrylic resin is not so high and the particle diameter of the pigment particles is not so large. Therefore, preservation stability of the pigment dispersion and ejection stability of the ink containing the pigment dispersion from the recording head are increased. R² preferably represents a hydrogen atom or an alkyl group with a carbon number of at least 1 and no greater than 3, more preferably represents a hydrogen atom or a methyl group, and further preferably represents a methyl group.

As described previously, m₁ represents an integer of at least 4 and no greater than 9. m₁ corresponds an added molar number in addition polymerization of ethylene oxide for obtaining polyethylene glycol or in addition polymerization of propylene oxide for obtaining polypropylene glycol.

The first repeating unit is a nonionic repeating unit. As described previously, the first-repeating-unit percentage is at least 1% by mass and no greater than 10% by mass. If the first-repeating-unit percentage exceeds 10% by mass, the nonionic first repeating unit is excessively much, so that the image density of an image formed with the ink containing the pigment dispersion is less than a desired value. If the first-repeating-unit percentage is less than 1% by mass or greater than 10% by mass, preservation stability of the pigment dispersion lowers. Furthermore, when the first-repeating-unit percentage is less than 1% by mass or greater than 10% by mass, the ink containing the pigment dispersion is likely to be unstably ejected from the recording head. As a result of the first-repeating-unit percentage being at least 1% by mass and no greater than 10% by mass, preservation stability of the pigment dispersion containing the specific styrene-acrylic resin increases. Also, ejection stability of the ink containing the pigment dispersion from the recording head increases to enable formation of images with desired image density with the ink.

A preferable example of the first repeating unit is a repeating unit represented by formula (2).

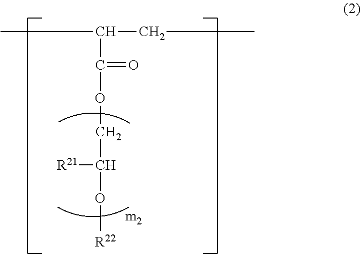

R²¹, R²², and m₂ in formula (2) are the same as defined for R¹, R², and m₁ in formula (1), respectively. Where R²¹ represents a hydrogen atom, the repeating unit represented by formula (2) is a repeating unit derived from polyethylene glycol acrylate. Where R²¹ represents a methyl group, the repeating unit represented by formula (2) is a repeating unit derived from polypropylene glycol acrylate.

The second repeating unit will be described next. Examples of the second repeating unit include a repeating unit derived from a styrene-based monomer and a repeating unit derived from an acrylic acid-based monomer. Any of the styrene-based monomers and any of the acrylic acid-based monomers listed below may be used for synthesizing the specific styrene-acrylic resin.

Examples of the styrene-based monomer include styrene, α-methylstyrene, p-hydroxystyrene, m-hydroxystyrene, vinyltoluene, α-chlorostyrene, o-chlorostyrene, m-chlorostyrene, p-chlorostyrene, and p-ethylstyrene.

Examples of the acrylic acid-based monomer include (meth)acrylic acid, (meth)acrylonitrile, (meth)acrylic acid alkyl ester, and (meth)acrylic acid hydroxyalkyl ester. Examples of the (meth)acrylic acid alkyl ester include methyl (meth)acrylate, ethyl (meth)acrylate, n-propyl (meth)acrylate, iso-propyl (meth)acrylate, n-butyl (meth)acrylate, iso-butyl (meth)acrylate, and 2-ethylhexyl (meth)acrylate. Examples of the (meth)acrylic acid hydroxyalkyl ester include 2-hydroxyethyl (meth)acrylate, 3-hydroxypropyl (meth)acrylate, 2-hydroxypropyl (meth)acrylate, and 4-hydroxybutyl (meth)acrylate.

Preferable examples of the second repeating unit include a repeating unit represented by formula (3) and a repeating unit represented by formula (4). The repeating unit represented by formula (3) is a repeating unit derived from styrene. The repeating unit represented by formula (4) is a repeating unit derived from acrylic acid. Preferably, the second repeating unit includes both the repeating unit represented by formula (3) and the repeating unit represented by formula (4).

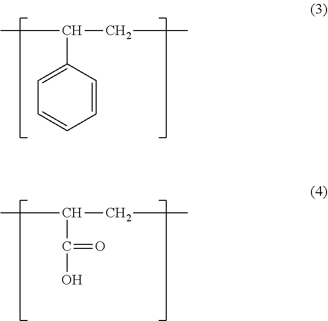

The specific styrene-acrylic resin preferably includes a repeating unit represented by formula (2), at least one repeating unit derived from a styrene-base monomer, and at least one repeating unit derived from an acrylic acid-based monomer. The specific styrene-acrylic resin more preferably includes a repeating unit represented by formula (2), the repeating unit represented by formula (3), and the repeating unit represented by formula (4).

A ratio (Wr/Wp) of the mass (Wr) of the specific styrene-acrylic resin to the mass (Wp) of the pigment particles is preferably at least 0.30 and no greater than 1.00, and more preferably at least 0.50 and no greater than 0.75. The specific styrene-acrylic resin hardly affects image density of images formed with the ink containing the pigment dispersion. Therefore, even when the specific styrene-acrylic resin is contained in a relatively large amount in such a range as at least 0.30 and no greater than 1.00 in terms of the ratio of the mass of the specific styrene-acrylic resin to the mass of the pigment particles, images with desired image density can be formed with the ink containing the pigment dispersion. Furthermore, the specific styrene-acrylic resin functioning as a dispersant can be contained in a relatively large amount, thereby enabling increase in preservation stability of the pigment dispersion. Also, the ink containing the pigment dispersion can be stably ejected from the recording head.

The percentage content of the specific styrene-acrylic resin to the mass of the pigment dispersion is preferably at least 1% by mass and no greater than 30% by mass, and more preferably at least 5% by mass and no greater than 15% by mass.

The pigment dispersion may further contain a resin (also referred to below as additional resin) in addition to the specific styrene-acrylic resin. Examples of the additional resin include styrene-maleic acid copolymers, styrene-maleic acid half-ester copolymers, vinylnaphthalene-acrylic acid copolymers, vinylnaphthalene-maleic acid copolymers, maleic acid resin, α-olefin maleic acid resin, urethane resin, ester resins, and acrylic resin.

(Pigment Particles)

The pigment particles preferably have a 10% cumulative diameter in terms of volume (10% volume cumulative diameter, also referred to below as D₁₀) of at least 50 nm and no greater than 80 nm. D₁₀ means a particle diameter at which the cumulative frequency from the small particle diameter side reaches 10% in a volume particle diameter distribution. Pigment particles on the small particle diameter side in the volume particles diameter distribution tend to have high chromaticity. When the D₁₀ is no greater than 80 nm, the number of pigment particles with high chromaticity on the small particle diameter side increases moderately. As a result, images with desired image density can be formed with the ink containing the pigment dispersion. As a result of the D₁₀ being set to no greater than 80 nm, the number of pigment particles on the small particle diameter side increases moderately to increase preservation stability of the pigment dispersion. Furthermore, as a result of the D₁₀ being set to no greater than 80 nm, the number of pigment particles on the small particle diameter side increases moderately to enable stable ejection of the ink containing the pigment dispersion from the recording head. Effects of ejection stability of the ink from the recording head is particularly significant in intermittent printing which tends to cause ink drying and sticking in the nozzles of the recording head. However, as a result of the D₁₀ of the pigment particles being set to at least 50 nm, the ink containing the pigment dispersion tends to be stably ejected from the recording head.

The pigment particles have a 50% cumulative diameter in terms of volume (50% volume cumulative diameter, also referred to below as D₅₀) of preferably at least 80 nm and no greater than 130 nm, and more preferably at least 85 nm and no greater than 130 nm. D₅₀ means a particle diameter at which the cumulative frequency from the small particle diameter side reaches 50% in the volume particle diameter distribution. As a result of the D₅₀ of the pigment particles being set to no greater than 130 nm, the pigment particles hardly agglomerate to increase preservation stability of the pigment dispersion. As a result of D₅₀ of the pigment particles being set to no greater than 130 nm, the pigment particles hardly agglomerate to enable stable ejection of the ink containing the pigment dispersion from the recording head. Effects of ejection stability of the ink from the recording head is particularly significant in intermittent printing which tends to cause ink drying and sticking in the nozzles of the recording head. However, as a result of the D₅₀ of the pigment particles being set to at least 80 nm, the pigment particles hardly enter into gaps between fibers of a recording medium and stay on the surface of the recording medium to enable formation of images with desired image density using the ink containing the pigment dispersion.

The pigment particles preferably have a 90% cumulative diameter in terms of volume (90% volume cumulative diameter, also referred to below as D₉₀) of at least 150 nm and no greater than 300 nm. D₉₀ is a particle diameter at which the cumulative frequency from the small particle diameter side reaches 90% in the volume particle diameter distribution. As a result of the D₉₀ of the pigment dispersion being set to no greater than 300 nm, the number of pigment particles on the large particle diameter side is not too large in the volume particle diameter distribution. Therefore, the pigment particles hardly agglomerate with a result that preservation stability of the pigment dispersion increases and the ink containing the pigment dispersion can be stably ejected from the recording head. Effects of ejection stability of the ink from the recording head is particularly significant in intermittent printing which tends to cause ink drying and sticking in the nozzles of the recording head. As a result of the D₉₀ of the pigment particles being set to no greater than 150 nm by contrast, the number of pigment particles on the large particle diameter side is moderately large in the volume particle diameter distribution. The pigment particles on the large particle diameter side fill gaps among fibers of a recording medium. As a result of the gaps being filled, the pigment particles with high chromaticity on the small particle diameter side hardly enter into the recording medium. The pigment particles with high chromaticity on the small particle diameter side stay on the recording medium to enable formation of images with desired image density with the ink containing the pigment dispersion.

Each of D₅₀, D₁₀, and D₉₀ of the pigment particles is measured by the same measurement method as that described later in Examples or a measurement method in accordance therewith using a dynamic light scattering type particle size distribution analyzer. Note that D₅₀, D₁₀, and D₉₀ of the pigment particles are values as measured for the pigment particles dispersed in a pigment dispersion and the pigment particles are aggregated particles as a result of aggregation of primary particles of a pigment.

The pigment particles have a number average primary particle diameter of no greater than 17 nm, for example. The pigment particles have a DBP oil absorption of no greater than 130 mL/100 g, for example. The pigment particles have a BET specific surface area of no greater than 300 m²/g, for example. Pigment particles (also referred to below as pigment particles A) having a number average primary particle diameter of no greater than 17 nm, a DBP oil absorption of no greater than 130 mL/100 g, and a BET specific surface area of no greater than 300 m²/g tend to have high chromaticity. However, the pigment particles A readily enter into the gaps between the fibers of a recording medium (e.g., paper) when the ink lands on the recording medium, tending to lower image density of an image formed on the recording medium. Here, the pigment dispersion according to the first embodiment contains the specific styrene-acrylic resin. As a result of the pigment dispersion containing the specific styrene-acrylic resin, the particle diameter of the pigment particles A dispersed in the pigment dispersion can be easily adjusted to exhibit a desired volume particle diameter distribution (to set D₅₀, D₁₀, and D₉₀ in the aforementioned respective favorable numeric ranges, for example). The pigment particles A hardly enter into the gaps between the fibers of the recording medium. This enables formation of images with desired image density even with the ink containing the pigment particles A.

No particular limitations are placed on the lower limit of the number average primary particle diameter of the pigment particles, and the lower limit thereof is at least 5 nm, for example.

The pigment particles preferably have a DBP oil absorption of no greater than 110 mL/100 g. No particular limitations are placed on the lower limit of the DBP oil absorption of the pigment particles, and the lower limit thereof is at least 50 mL/100 g, for example.

The pigment particles preferably have a BET specific surface area of no greater than 280 m²/g. No particular limitations are placed on the lower limit of the BET specific surface area of the pigment particles, and the lower limit thereof is at least 180 m²/g, for example.

Examples of a pigment that can be used as the pigment particles include a yellow pigment, an orange pigment, a red pigment, a blue pigment, a violet pigment, and a black pigment. Examples of the yellow pigment include C.I. Pigment Yellow 74, 93, 95, 109, 110, 120, 128, 138, 139, 151, 154, 155, 173, 180, 185, or 193. Examples of the orange pigment include C.I. Pigment Orange 34, 36, 43, 61, 63, or 71. Examples of the red pigment include C.I. Pigment Red 122 or 202. Quinacridone-magenta (PR122) may be used as the red pigment. Examples of the blue pigment include C.I. Pigment Blue 15 or 15:3. Examples of the violet pigment include C.I. Pigment Violet 19, 23, or 33. Examples of the black pigment include C.I. Pigment Black 4 or 7. Carbon black may be used as the black pigment.

In terms of easy adjustment of the DBP oil absorption and the BET specific surface area, carbon black is preferable as the pigment that can be used as the pigment particles. Examples of the carbon black include furnace black, channel black, thermal black, and acetylene black. Examples of commercially available carbon black that can be used include COLOUR BLACK S160 (DBP oil absorption 128 mL/100 g, BET specific surface area 180 m²/g), SPECIAL BLACK 4 (DBP oil absorption 115 mL/100 g, BET specific surface area 180 m²/g), SPECIAL BLACK 4A (DBP oil absorption 95 mL/100 g, BET specific surface area 180 m²/g), PRINTEX (registered Japanese trademark) U (DBP oil absorption 115 mL/100 g, BET specific surface area 92 m²/g), PRINTEX V (DBP oil absorption 115 mL/100 g, BET specific surface area 92 m²/g), PRINTEX 140U (DBP oil absorption 115 mL/100 g, BET specific surface area 90 m²/g), PRINTEX 140V (DBP oil absorption 115 mL/100 g, BET specific surface area 90 m²/g), PRINTEX 95 (DBP oil absorption 52 mL/100 g, BET specific surface area 240 m²/g), HIBLACK 970LB (DBP oil absorption 65 mL/100 g, BET specific surface area 295 m²/g), HIBLACK 930L (DBP oil absorption 65 mL/100 g, BET specific surface area 275 m²/g), HIBLACK 890 (DBP oil absorption 95 mL/100 g, BET specific surface area 270 m²/g), PINTEX 85 (DBP oil absorption 54 mL/100 g, BET specific surface area 200 m²/g), PRINTEX 80 (DBP oil absorption 105 mL/100 g, BET specific surface area 225 m²/g), PRINTEX 75 (DBP oil absorption 53 mL/100 g, BET specific surface area 145 m²/g), HIBLACK 600L (DBP oil absorption 72 mL/100 g, BET specific surface area 235 m²/g), HIBLACK 50L (DBP oil absorption 55 mL/100 g, BET specific surface area 188 m²/g), PRINTEX F85 (DBP oil absorption 45 mL/100 g, BET specific surface area 200 m²/g), PRINTEX F80 (DBP oil absorption 105 mL/100 g, BET specific surface area 225 m²/g), PRINTEX Falfa (DBP oil absorption 100 mL/100 g, BET specific surface area 105 m²/g), and PRINTEX FP (DBP oil absorption 102 mL/100 g, BET specific surface area 120 m²/g) each produced by Orion Engineered Carbons KK.

The percentage content of the pigment particles to the mass of the pigment dispersion is preferably at least 5% by mass and no greater than 30% by mass, and more preferably at least 10% by mass and no greater than 20% by mass.

(Water)

The water is preferably ion exchange water or deionized water. The percentage content of the water to the mass of the pigment dispersion is preferably at least 60% by mass and no greater than 9% by mass.

(Additive)

The pigment dispersion may further contain an additive as necessary. Examples of the additive include a solution stabilizer, a moisturizing agent, a penetrating agent, a viscosity modifier, a defoaming agent, and preservative.

(Pigment Dispersion Production Method)

An example of a method for producing the pigment dispersion of the present embodiment will be described next. The pigment dispersion is obtained by mixing the pigment particles, the specific styrene-acrylic resin, the water, and a component (e.g., an additive) to be added as necessary using a disperser. Examples of the disperser include a sand mill, a ball mill, a roll mill, a bead mill, a Nanomizer, a paint shaker, an ultrasonic disperser, and a homogenizer. In terms of yielding high dispersibility, the disperser is preferably a media disperser, and more preferably a bead mill. In terms of yielding high dispersibility, the material of the beads used in the bead mill is preferably ceramic, glass, stainless steel, or zirconia, and more preferably zirconia. In terms of yielding high dispersibility, the diameter of the beads used in the bead mill is preferably at least 0.03 mm and no greater than 0.50 mm, and more preferably at least 0.03 mm and no greater than 0.30 mm.

### Second Embodiment: Ink

A second embodiment of the present disclosure relates to an ink. The ink of the second embodiment contains the pigment dispersion of the first embodiment and a water-soluble organic solvent. The ink of the second embodiment is a water-based ink containing the pigment dispersion which contains water. The ink of the second embodiment may further contain a surfactant, a polysaccharide, and water (specifically, water additionally added in addition to the water contained in the pigment dispersion) as necessary.

(Pigment Dispersion)

The pigment dispersion contained in the ink of the second embodiment is the pigment dispersion of the first embodiment. As described previously, the pigment dispersion of the first embodiment is excellent in preservation stability. As a result of containing such a pigment dispersion excellent in preservation stability, the ink of the second embodiment is also excellent in preservation stability. Furthermore, as a result of being contained in an ink, the pigment dispersion of the first embodiment can allow the ink to be stably ejected from the recording head, thereby achieving formation of images with desired image density as described preciously. For the same reasons as those described in the first embodiment, the ink of the second embodiment can be stably ejected from the recording head and can form images with desired image density.

The pigment dispersion of the first embodiment contained in the ink contains the pigment particles and the specific styrene-acrylic resin. The percentage content of the pigment particles to the mass of the ink is preferably at least 4% by mass and no greater than 10% by mass, and more preferably at least 4% by mass and no greater than 8% by mass. As a result of the percentage content of the pigment particles to the mass of the ink being set to at least 4% by mass, images with desired image density can be easily formed. As a result of the percentage content of the pigment particles to the mass of the ink being set to no greater than 8% by mass, dispersion stability of the ink increases. In order to favorably disperse the pigment particles in the ink, the percentage content of the specific styrene-acrylic resin to the mass of the ink is preferably at least 0.1% by mass and no greater than 15% by mass, and more preferably at least 1% by mass and no greater than 9% by mass.

(Water-soluble Organic Solvent)

Examples of the water-soluble organic solvent include alcohols, glycol compounds, polyhydric alcohol ether compounds, lactam compounds, nitrogen-containing compounds other than the lactam compounds, acetate compounds, thiodiglycol, glycerin, and dimethyl sulfoxide.

Examples of the alcohols include methanol, ethanol, 1-propanol, and 2-propanol.

The glycol compounds are diol compounds with two carbon atoms to each of which a hydroxy group is bonded. Preferable examples of the glycol compounds include alkylene glycol and polyalkylene glycol. Alkylene glycol and polyalkylene glycol may each have a straight chain or blanched chain structure. Examples of the glycol compounds include ethylene glycol, propylene glycol, diethylene glycol, 1,3-butanediol (i.e., 1,3-butylene glycol), 1,3-propanediol, triethylene glycol, tetraethylene glycol, 1,4-butanediol, 1,5-pentanediol, 2-methyl-1,3-propanediol, 2,2-dimethyl-1,3-propanediol, 3-methyl-1,5-pentanediol, 1,6-hexanediol, 3-methoxyl-1-butanol, 3-methoxy-3-methylbutanol, 1,2-propanediol, 1,2-butanediol, 3-methyl-1,3-butanediol, and 1,2-octanediol.

Examples of the polyhydric alcohol ether compounds include ethylene glycol monoethyl ether, ethylene glycol monobutyl ether, diethylene glycol diethyl ether, diethylene glycol monobutyl ether, diethylene glycol monopropyl ether, diethylene glycol monopentyl ether, ethylene glycol monomethyl ether, ethylene glycol monobutyl ether, diethylene glycol monomethyl ether, diethylene glycol monoethyl ether, diethylene glycol diethyl ether, triethylene glycol monomethyl ether, triethylene glycol monoethyl ether, triethylene glycol monopropyl ether, triethylene glycol monobutyl ether, tetraethylene glycol monomethyl ether, dipropylene glycol monomethyl ether, diethylene glycol dimethyl ether, triethylene glycol dimethyl ether, tetraethylene glycol dimethyl ether, triethylene glycol diethyl ether, tetraethylene glycol diethyl ether, diethylene glycol methyl ethyl ether, triethylene glycol methyl ethyl ether, tetraethylene glycol methyl ethyl ether, tetraethylene glycol butyl methyl ether, propylene glycol dimethyl ether, and propylene glycol monomethyl ether.

Examples of the lactam compounds include 2-pyrrolidone, N-methyl-2-pyrrolidone, and N-ethylpyrrolidone.

Examples of the lactam compounds include 1,3-dimethylimidazolidinone, formamide, dimethyl formamide, 3-methyl-2-oxazolidinone, 3-ethyl-2-oxiazolidinone, N,N-dimethyl-ρ-methoxypropionamide, N,N-dimethyl-σ-ethoxypropionamide, N,N-dimethyl-β-butoxypropionamide, N,N-dimethyl-β-pentoxypropionamide, N,N-dimethyl-β-hexoxypropionamide, N,N-dimethyl-β-heptoxypropionamide, N,N-dimethyl-β-2-ethylhexoxypropionamide, N,N-dimethyl-β-octoxypropionamide, N,N-diethyl-β-butoxypropionamide, N,N-diethyl-β-pentoxypropionamide, N,N-diethyl-β-hexoxypropionamide, N,N-diethyl-β-heptoxypropionamide, and N,N-diethyl-β-octoxypropionamide.

Examples of the acetate compounds include diethylene glycol monoethyl ether acetate.

The water-soluble organic solvent is preferably at least one (preferably, at least one and no greater than seven) selected from the group consisting of glycol compounds, polyhydric alcohol ether compounds, lactam compounds, and glycerin. More preferably, the water-soluble organic solvent is at least one (preferably, at least one and no greater than seven) selected from the group consisting of 3-methyl-1,5-pentanediol, triethylene glycol monobutyl ether, glycerin, 2-pyrrolidone, 1,2-octanediol, 1,3-propanediol, and 1,5-pentanediol. The percentage content of the water-soluble organic solvent to the mass of the ink is preferably at least 30% by mass and no greater than 55% by mass.

(Polysaccharide)

Examples of the polysaccharide include sorbitol, gum arabic, and xanthan gum. Preferably, the polysaccharide is sorbitol. The percentage content of the polysaccharide to mass of the ink is preferably at least 0.01% by mass and no greater than 5.00% by mass.

(Surfactant)

When the ink contains a surfactant, wettability of the ink to a recording medium is increased. The surfactant may be any of an anionic surfactant, a cationic surfactant, a nonionic surfactant, and an amphoteric surfactant. Examples of the surfactant includes acetylene surfactants, silicone surfactants, acrylic surfactants, and fluorine-containing surfactants. The surfactant is preferably a nonionic surfactant. A preferable nonionic surfactant is an acetylene surfactant, and a more preferable nonionic surfactant is an ethylene oxide adduct of acetylene glycol. The acetylene surfactant means a surfactant having an acetylene bond in the present specification. The surfactant has a hydrophilic-lipophilic balance (HLB) value of preferably at least 3 and no greater than 20, more preferably at least 6 and no greater than 16, and further preferably at least 13 and no greater than 14. The HLB value of the surfactant is calculated by the Griffin's method using a formula “HLB value=20×(total sum of formula weights of hydrophilic portions)/(molecule weight)”. The percentage content of the surfactant to mass of the ink is preferably at least 0.01% by mass and no greater than 5.00% by mass.

(Water)

The water additionally added in addition to the water contained in the pigment dispersion is preferably ion exchange water or deionized water. The total percentage content of the water contained in the pigment dispersion and the water additionally added in addition to the water contained in the pigment dispersion is preferably at least 40% by mass and no greater than 90% by mass to the mass of the ink, and more preferably at least 40% by mass and no greater than 70% by mass.

(Additive)

The ink may further contain an additive as necessary. Examples of the additive that may be contained in the ink include those listed as the examples of the additive that may be contained in the pigment dispersion.

<Ink Production Method>

An example of a method for producing the ink of the second embodiment will be described next. A mixed liquid is obtained by mixing the pigment dispersion of the first embodiment, the water-soluble organic solvent, and a component (e.g., a surfactant, a polysaccharide, water additionally added in addition to the water contained in the pigment dispersion, and an additive) added as necessary using a stirrer. The resultant mixed liquid is filtered according to necessity. The ink of the second embodiment is obtained in the manner described above.

### EXAMPLES

Examples of the present disclosure will be described next. In evaluation in which errors might occur, a significant number of measured values were obtained for which the errors were sufficiently small, and the arithmetic mean of the measured values was taken to be an evaluation value. Ion exchange water was used as water.

[Styrene-acrylic Resin Preparation]

Styrene-acrylic resins (R-1) to (R-13) were synthesized for use in pigment dispersion preparation. Table 1 shows monomers used for synthesis of these styrene-acrylic resins and their amounts.

TABLE 1

| | | | First repeating unit monomer | | | |
|---|---|---|---|---|---|---|
| | Styrene | Acrylic acid | | | Added | |
| | Amount | Amount | Amount | | molar | |
| Resin | [g] | [g] | [g] | Type | number | End group |
| R-1 | 60 | 35 | 5 | PEGA | 4 | Methyl |
| R-2 | 60 | 30 | 10 | PEGA | 9 | Methyl |
| R-3 | 59 | 35 | 6 | PEGA | 4 | Hydrogen |
| R-4 | 60 | 37 | 3 | PPGA | 4 | Methyl |
| R-5 | 57 | 42 | 1 | PPGA | 7 | Hydrogen |
| R-6 | 56 | 36 | 8 | PEGA | 6 | C7 alkyl |
| R-7 | 55 | 40 | 5 | PEGA | 2 | Methyl |
| R-8 | 59 | 34 | 7 | PPGA | 14 | Methyl |
| R-9 | 66 | 32 | 2 | PPGA | 20 | Methyl |
| R-10 | 60 | 40 | — | — | — | — |
| R-11 | 70 | 15 | 15 | PEGA | 9 | Hydrogen |
| R-12 | 60 | 35 | 5 | PEGA | 4 | C20 alkyl |
| R-13 | 50 | 38 | 12 | PEGA | 9 | C20 alkyl |

The terms in Table 1 are defined as follows.
Resin: styrene-acrylic resin
First repeating unit monomer: monomer for forming first repeating unit
wt %: % by mass
PEGA: polyethylene glycol acrylate
PPGA: polypropylene glycol acrylate
Added molar number: added molar number (corresponding to m₁ in formula (1)) of ethylene oxide forming polyethylene glycol acrylate or propylene oxide forming polypropylene glycol acrylate
End group: end group (corresponding to R² in formula (1)) forming polyethylene glycol acrylate or polypropylene glycol acrylate
C7 alkyl: alkyl group with a carbon number of 7
C20 alkyl: alkyl group with a carbon number of 20
-: not including corresponding repeating unit

Note that the mass of a monomer corresponds to the mass of a formed repeating unit because styrene-acrylic resin is formed through addition polymerization of a vinyl group. The total amount of monomers used for forming each styrene-acrylic resin is 100 g. Therefore, the amount of each monomer corresponds to a percentage content (unit: % by mass) of a repeating unit derived from the monomer to the total mass of the first repeating unit and the second repeating unit. Referring to a styrene-acrylic resin (R-1), for example, the percentage content of a repeating unit derived from styrene, the percentage content of the repeating unit derived from acrylic acid, and the percentage content of a repeating unit derived from polyethylene glycol acrylate are respectively 60% by mass, 35% by mass, and 5% by mass to the total mass of the first repeating unit and the second repeating unit (specifically, total mass of styrene, acrylic acid, and polyethylene glycol acrylate).

<Preparation of Styrene-acrylic Resin (R-1)>

A stirrer, a nitrogen inlet tube, a condenser (stirrer), and a dropping funnel were set at a four-necked flask. Next, 100 g of isopropyl alcohol and 300 g of methyl ethyl ketone were added into the flask. Heat reflux at 70° C. was carried on the flask contents under nitrogen bubbling. A monomer solution A was obtained by mixing 60 g of styrene, 35 g of acrylic acid, 5 g of polyethylene glycol acrylate (added molar number: 4, end group: methyl group), and 0.4 g of azobisisobutyronitrile (AIBN) being a polymerization initiator. The monomer solution A was dripped into the flask over 2 hours under heat reflux at 70° C. After the dripping, heat reflux at 70° C. was further carried out for 6 hours. A solution B was obtained by mixing 0.2 g of AIBN and methyl ethyl ketone. The solution B was dripped into the flask over 15 minutes. After the dripping, heat reflux at 70° C. was further carried out for 5 hours. Through the above, a styrene-acrylic resin (R-1) was obtained.

<Preparation of Styrene-Acrylic Resins (R-2) to (R-9) and (R-11) to (R-13)>

Styrene-acrylic resins (R-2) to (R-9) and (R-11) to (R-13) were prepared according to the same method as that for preparing the styrene-acrylic resin (R-1) in all aspects other than use of monomers for forming the first repeating units shown in Table 1 and use of styrene, acrylic acid, and the monomers for forming the first repeating units in the respective amounts shown in Table 1.

<Preparation of Styrene-Acrylic Resin (R-10)>

A styrene-acrylic resin (R-10) was prepared according to the same method as that for preparing the styrene-acrylic resin (R-1) in all aspects other than nonuse of a monomer for forming the first repeating unit and use of styrene and acrylic acid in the respective amounts shown in Table 1.

[Pigment Dispersion Preparation]

Pigment dispersions (D-1) to (D-9) of Examples and pigment dispersions (D-10) to (D-16) of Comparative Examples were prepared. Table 2 shows the compositions of these pigment dispersions.

TABLE 2

| | Pigment | | Resin | | Defoaming agent | Water | |
|---|---|---|---|---|---|---|---|
| Pigment | | Amount | | Amount | Percentage content | Amount | Resin/ |
| dispersion | Type | [part] | Type | [part] | [wt %] | [part] | pigment |
| D-1 | PRINTEX 80 | 15.0 | R-1 | 8.0 | 0.1 | Rest | 0.53 |
| D-2 | PRINTEX 85 | 15.0 | R-2 | 10.0 | 0.1 | Rest | 0.67 |
| D-3 | #960 | 15.0 | R-3 | 9.0 | 0.1 | Rest | 0.60 |
| D-4 | PRINTEX 80 | 15.0 | R-4 | 9.0 | 0.1 | Rest | 0.60 |
| D-5 | PRINTEX 85 | 15.0 | R-5 | 10.0 | 0.1 | Rest | 0.67 |
| D-6 | #960 | 15.0 | R-6 | 8.0 | 0.1 | Rest | 0.53 |
| D-7 | PRINTEX 80 | 10.0 | R-1 | 5.0 | 0.1 | Rest | 0.50 |
| D-8 | PRINTEX 85 | 20.0 | R-2 | 15.0 | 0.1 | Rest | 0.75 |
| D-9 | #960 | 18.0 | R-3 | 12.0 | 0.1 | Rest | 0.67 |
| D-10 | PRINTEX 80 | 15.0 | R-7 | 10.0 | 0.1 | Rest | 0.67 |
| D-11 | PRINTEX 85 | 15.0 | R-8 | 11.0 | 0.1 | Rest | 0.73 |
| D-12 | #960 | 15.0 | R-9 | 9.5 | 0.1 | Rest | 0.63 |
| D-13 | PRINTEX 80 | 15.0 | R-10 | 9.0 | 0.1 | Rest | 0.60 |
| D-14 | PRINTEX 85 | 15.0 | R-11 | 10.5 | 0.1 | Rest | 0.70 |
| D-15 | #960 | 15.0 | R-12 | 8.0 | 0.1 | Rest | 0.53 |
| D-16 | PRINTEX 80 | 15.0 | R-13 | 7.0 | 0.1 | Rest | 0.47 |

The terms in Table 2 are defined as follows.
Part: parts by mass
Resin: styrene-acrylic resin
Defoaming agent: product of SAN NOPCO LIMITED, “SN DEFOAMER 1340”
Resin/pigment: ratio of mass of styrene-acrylic resin to mass of pigment particles
PRINTEX 80: carbon black (product of Orion Engineered Carbons KK, “PRINTEX (registered Japanese trademark) 80”, DBP oil absorption: 105 mL/100 g, BET specific surface area: 225 m²/g, number average primary particle diameter: 16 nm)
PRINTEX 85: carbon black (product of Orion Engineered Carbons KK, “PRINTEX (registered Japanese trademark) 85”, DBP oil absorption: 54 mL/100 g, BET specific surface area: 200 m²/g, number average primary particle diameter: 16 nm)
#960: carbon black (product of Mitsubishi Chemical Corporation “#960”, DBP oil absorption: 69 mL/100 g, BET specific surface area: 260 m²/g, number average primary particle diameter: 16 nm)
Rest: remaining amount that brings total mass of components contained in corresponding pigment dispersion to 100.0 parts by mass. In preparation of the pigment dispersion (D-1), for example, the remaining amount was 76.9 parts by mass (=100.0−(15.0+8.0+0.1))

<Preparation of Pigment Dispersion (D-1)>

A mixed liquid was obtained by mixing 15.0 parts by mass of carbon black (product of Orion Engineered Carbons KK, “PRINTEX (registered Japanese trademark) 80”), 8.0 parts by mass of the styrene-acrylic resin (R-1), 0.1 parts by mass of a defoaming agent (product of SAN NOPCO LIMITED, “SN DEFOAMER 1340”), and the remaining amount of water. Using a bead mill (product of Willy A. Bachofen AG, “DYNO (registered Japanese trademark) MILL”, Type: DYNO (registered Japanese trademark)-MILL MULTI-LAB), the mixed liquid was further mixed to disperse the carbon black in the mixed liquid. The dispersion using the bead mill was carried out under conditions of use of zirconia beads with a diameter of 0.3 mm as a medium, a filling rate of the medium of 60%, a rotational speed of the bead mill of 10 m/sec., a dispersion time of 4 hours, and a chiller temperature of 10° C. After the dispersion, the mixed liquid was taken out of the bead mill, and filtered using a membrane filter with a pore size of 5 m to obtain a pigment dispersion (D-1).

<Preparation of Pigment Dispersions (D-2) to (D-16)>

Pigment dispersions (D-2) to (D-16) were prepared according to the same method as that for preparing the pigment dispersion (D-1) in all aspects other than use of the pigments shown in Table 2 in the respective amounts shown in Table 2, use of the styrene-acrylic resins shown in Table 2 in the respective amounts shown in Table 2, and change in amount of water to bring the amount of water to the remaining amount.

[Ink Preparation]

Inks (I-1) to (I-9) of Examples and inks (I-10) to (1-16) of Comparative Examples were prepared. Compositions of these inks are shown in Tables 3 and 4.

TABLE 3

| Ink | | I-1 | I-2 | I-3 | I-4 | I-5 | I-6 | I-7 | I-8 | I-9 |
|---|---|---|---|---|---|---|---|---|---|---|
| Amount | D-1 | 42.0 | — | — | — | — | — | — | — | — |
| [part] | D-2 | — | 40.0 | — | — | — | — | — | — | — |
| | D-3 | — | — | 42.0 | — | — | — | — | — | — |
| | D-4 | — | — | — | 40.0 | — | — | — | — | — |
| | D-5 | — | — | — | — | 40.0 | — | — | — | — |
| | D-6 | — | — | — | — | — | 40.0 | — | — | — |
| | D-7 | — | — | — | — | — | — | 40.0 | — | — |
| | D-8 | — | — | — | — | — | — | — | 30.0 | — |
| | D-9 | — | — | — | — | — | — | — | — | 35.0 |
| | MPD | 10.0 | 10.0 | 8.9 | 9.0 | 9.0 | 9.5 | 9.0 | 9.0 | 9.0 |
| | TGME | 12.0 | 8.0 | 9.0 | 10.0 | 8.5 | 8.0 | 11.0 | 10.0 | 12.0 |
| | Glycerin | 6.0 | 5.0 | 4.0 | 4.8 | 6.5 | 7.0 | 3.0 | 4.0 | 4.0 |
| | 2-Pyrrolidone | 2.0 | 2.0 | 2.0 | 2.0 | 2.0 | 2.0 | 2.0 | 2.0 | 2.0 |
| | 1,2-Octanediol | 0.5 | 0.5 | 0.5 | 0.5 | 0.5 | 0.5 | 0.5 | 0.5 | 0.5 |
| | Sorbitol | 0.1 | 0.1 | 0.1 | 0.1 | 0.1 | 0.1 | 0.1 | 0.1 | 0.1 |
| | 1,3-Propanediol | 5.0 | 5.0 | 9.0 | 9.0 | 6.0 | 8.0 | 7.0 | 9.0 | 8.0 |
| | 1,5-Pentanediol | 6.0 | 9.0 | 7.0 | 5.0 | 7.0 | 5.0 | 8.0 | 6.0 | 5.0 |
| | Olefin | 0.5 | 0.5 | 0.5 | 0.5 | 0.5 | 0.5 | 0.5 | 0.5 | 0.5 |
| | Water | Rest | Rest | Rest | Rest | Rest | Rest | Rest | Rest | Rest |

TABLE 4

| Ink | | I-10 | I-11 | I-12 | I-13 | I-14 | I-15 | I-16 |
|---|---|---|---|---|---|---|---|---|
| Amount | D-10 | 40.0 | — | — | — | — | — | — |
| [part] | D-11 | — | 41.0 | — | — | — | — | — |
| | D-12 | — | — | 40.0 | — | — | — | — |
| | D-13 | — | — | — | 40.0 | — | — | — |
| | D-14 | — | — | — | — | 40.0 | — | — |
| | D-15 | — | — | — | — | — | 40.0 | — |
| | D-16 | — | — | — | — | — | — | 40.0 |
| | MPD | 10.0 | 8.9 | 9.0 | 9.0 | 9.0 | 10.0 | 10.0 |
| | TGME | 9.0 | 8.9 | 10.0 | 8.9 | 8.9 | 9.0 | 9.0 |
| | Glycerin | 7.1 | 7.1 | 6.5 | 7.0 | 5.9 | 7.1 | 8.0 |
| | 2-Pyrrolidone | 2.0 | 2.0 | 2.0 | 2.0 | 2.0 | 2.0 | 2.0 |
| | 1,2-Octanediol | 0.5 | 0.5 | 0.5 | 0.5 | 0.5 | 0.5 | 0.5 |
| | Sorbitol | 0.1 | 0.1 | 0.1 | 0.1 | 0.1 | 0.1 | 0.1 |
| | 1,3-Propanediol | 7.0 | 8.0 | 9.0 | 8.0 | 9.0 | 8.0 | 8.0 |
| | 1,5-Pentanediol | 4.0 | 5.0 | 4.0 | 5.0 | 5.0 | 4.0 | 4.0 |
| | Olefin | 0.5 | 0.5 | 0.5 | 0.5 | 0.5 | 0.5 | 0.5 |
| | Water | Rest | Rest | Rest | Rest | Rest | Rest | Rest |

The terms in Tables 3 and 4 are defined as follows.
D-1 to D-16: pigment dispersions (D-1) to (D-16)
Part: parts by mass
MPD: 3-methyl-1,5-pentanediol
TGME: triethylene glycol monobutyl ether
Olefin: acetylene surfactant (product of Nissin Chemical Industry Co., Ltd., “OLFINE (registered Japanese trademark) E1010”, effective component concentration: 100% by mass, HLB value: 13.5)
Rest: remaining amount that brings total mass of components contained in corresponding ink to 100.0 parts by mass. In the preparation of the ink (I-1), for example, the remaining amount was 15.9 parts by mass (=100.0−(42.0+10.0+12.0+6.0+2.0+0.5+0.1+5.0+6.0+0.5)).

<Preparation of Ink (I-1)>

A mixed liquid was obtained by mixing 42.0 parts by mass of the pigment dispersion (D-1), 10.0 parts by mass of 3-methyl-1,5-pentanediol, 12.0 parts by mass of triethylene glycol monobutyl ether, 6.0 parts by mass of glycerin, 2.0 parts by mass of 2-pyrrolidone, 0.5 parts by mass of 1,2-octanediol, 0.1 parts by mass of sorbitol, 0.5 parts by mass of an acetylene surfactant (product of Nissin Chemical Industry Co., Ltd., “OLFINE (registered Japanese trademark) E1010”), 5.0 parts by mass of 1,3-propanediol, 6.0 parts by mass of 1,5-pentanediol, and 15.9 parts by mass of water at a rotational speed of 3000 rpm for 20 minutes using a homomixer (product of PRIMIX Corporation) in a normal-temperature (25° C.) environment. The resultant mixed liquid was filtered using a membrane filter with a pore size of 5 m to obtain an ink (I-1).

<Preparation of Inks (I-2) to (I-16)>

Inks (I-2) to (I-16) were prepared according to the same method as that for preparing the ink (I-1) in all aspects other than use of the components shown in Tables 3 and 4 in the respective amounts shown in Tables 3 and 4.

[Measurement]

<Measurement of D₁₀, D₅₀, and D₉₀ of Pigment Particles>

Each of the pigment dispersions was diluted 100 times with water and the diluted pigment dispersion was used as a measurement sample. Each of D₁₀, D₅₀, and D₉₀ of the pigment particles in the measurement sample was measured in an environment at a temperature of 25° C. using a dynamic light scattering type particle size distribution analyzer (product of Malvern Instruments Ltd., “ZETASIZER NANO ZS”). The D₁₀, D₅₀, and D₉₀ of the pigment particles in the measurement sample were respectively taken to be D₁₀, D₅₀, and D₉₀ of the pigment particles contained in the pigment dispersion. Note that in measurement of the D₁₀, D₅₀, and D₉₀ of the pigment particles contained in an ink, the ink was diluted 100 times with water and the diluted ink was used as a measurement sample.

Viscosity Measurement>

The viscosity of each pigment dispersion and the viscosity of each ink were measured in an environment at a temperature of 25° C. using an oscillation viscometer (product of SEKONIC CORPORATION, “VM-10A-L”).

[Evaluation]

The following evaluations were carried out for each of the pigment dispersions (D-1) to (D-16) and each of the inks (I-1) to (I-16). Tables 5 and 6 show values measured in the evaluations and evaluation results.

<Evaluation of Preservation Stability of Pigment Dispersion>

With respect to each of the pigment dispersions before storage, the D₅₀ of the pigment particles contained in the pigment dispersion and the viscosity of the pigment dispersion were measured first and taken to be a pre-storage particle diameter D₁ and a pre-storage viscosity V1, respectively. Next, the pigment dispersion was stored according to the following method. That is, a vessel with a capacity of 50 mL was charged with 30 g of the pigment dispersion, and hermitically sealed. The vessel containing the pigment dispersion was put into a thermostatic chamber of which inner temperature was set to 60° C., and left to stand for 1 month. Thereafter, the vessel containing the pigment dispersion was taken out of the thermostatic chamber and left to stand for 3 hours at room temperature. After the above storage of the pigment dispersion was carried out, the D₅₀ of the pigment particles contained in the pigment dispersion and the viscosity of the pigment dispersion were measured after the storage and taken to be a post-storage particle diameter D₂ and a post-storage viscosity V2, respectively. Note that the pre-storage particle diameter D₁ and the post-storage particle diameter D₂ were measured according to the method described above in <Measurement of D₁₀, D₅₀, and D₉₀ of Pigment Particles>. Also, the pre-storage viscosity V1 and the post-storage viscosity V2 were measured according to the method described above in <Viscosity Measurement>. A particle diameter change rate was calculated from the pre-storage particle diameter D₁ and the post-storage particle diameter D₂ measured as above using formula (a). Also, a viscosity change rate was calculated from the pre-storage viscosity V1 and the post-storage viscosity V2 measured as above using formula (b). From the particle diameter change rate and the viscosity change rate calculated as above, preservation stability of the pigment dispersion was evaluated according to the following criteria.

Particle diameter change rate (%)=100×(D₂−D₁)/D₁ . . . (a)

Viscosity change rate (%)=100×(V2−V1)/V1 . . . (b)

(Evaluation Criteria for Preservation Stability of Pigment Dispersion)

A: both particle diameter change rate and viscosity change rate being at least −5.0% and no greater than 5.0%.

B: at least one of particle diameter change rate and viscosity change rate being less than −5.0% or greater than 5.0%

<Evaluation of Preservation Stability of Ink>

With respect to each of the inks, preservation stability of the ink was evaluated according to the same method as the method described above in Evaluation of Preservation Stability of Pigment Dispersion> in all aspects other than change from the pigment dispersion to the ink. From the particle diameter change rate and the viscosity change rate calculated as above, preservation stability of the ink was evaluated according to the following criteria.

(Evaluation Criteria for Preservation Stability of Ink)

A: both particle diameter change rate and viscosity change rate being at least −5% and no greater than 5%.

B: at least one of particle diameter change rate and viscosity change rate being less than −5% or greater than 5%

<Evaluation of Image Density of Image Formed with Ink>

Evaluation of image density of an image formed with the ink was carried out in an environment at a temperature of 25° C. and a relative humidity of 50% using an inkjet recording apparatus (prototype produced by KYOCERA Document Solutions Japan Inc.) including a line type recording head as an evaluation apparatus. Plain paper (A4-size PPC paper, product of Fuji Xerox Co., Ltd., “C2”) was used as a recording medium. The ink was charged into a recording head for black of the evaluation apparatus. The amount of the ink ejected from the recording head toward the recording medium was set to 11 pL per pixel. A solid image with a length of 10 cm and a width of 10 cm was printed on the recording medium using the evaluation apparatus. The image density of the printed image was measured using a reflectance densitometer (product of X-Rite Inc., “RD-19”). The image density was measured at each of 10 locations in the formed image, and an average value thereof was taken to be an image density. The image density was evaluated according to the following criteria.

(Evaluation Criteria for Image Density)

A: image density of at least 1.15

B: image density of less than 1.15

Evaluation of Ejection Stability of Ink>

Evaluation of ejection stability of the ink was carried out in an environment at a temperature of 25° C. and a relative humidity of 50% using an inkjet recording apparatus (prototype produced by KYOCERA Document Solutions Japan Inc.) including a line type recording head as an evaluation apparatus. Plain paper (A4-size PPC paper, product of Fuji Xerox Co., Ltd., “C2”) was used as a recording medium. A solid image with a size of 150 mm×200 mm was consecutively printed on 100 sheets of the recording medium using the evaluation apparatus. Next, purging and wiping were performed and a nozzle check image was printed then. The printed nozzle check image was observed to confirm that the ink was ejected from all the nozzles of the recording head. Next, purging and wiping were re-performed and the evaluation apparatus was left to stand for 7 days with the recording head uncapped. After the 7-day leaving, purging and wiping were re-performed and the nozzle check image was re-printed. The resultant image was taken to be an evaluation image. The evaluation image was observed to count the number of nozzles (nozzle clogging number) of the nozzles of the recording head from which the ink has not been ejected due to nozzle clogging. A nozzle clogging rate (unit: % by number) was calculated using an equation “(nozzle clogging rate)=100×(nozzle clogging number)/(total number of nozzles of recording head)”. From the nozzle clogging rate, ejection stability of the ink was evaluated according to the following criteria.

(Criteria for Ejection Stability)

A: nozzle clogging rate of less than 10% by number

B: nozzle clogging rate of at least 10% by number

TABLE 5

| | | Exam- | Exam- | Exam- | Exam- | Exam- | Exam- | Exam- | Exam- | Exam- |
|---|---|---|---|---|---|---|---|---|---|---|
| | | ple 1 | ple 2 | ple 3 | ple 4 | ple 5 | ple 6 | ple 7 | ple 8 | ple 9 |
| Pigment dispersion | | D-1 | D-2 | D-3 | D-4 | D-5 | D-6 | D-7 | D-8 | D-9 |
| Ink | | I-1 | I-2 | I-3 | I-4 | I-5 | I-6 | I-7 | I-8 | I-9 |
| D10 | [nm] | 69 | 52 | 71 | 61 | 56 | 64 | 78 | 58 | 72 |
| D50 | [nm] | 119 | 97 | 117 | 110 | 88 | 123 | 126 | 91 | 104 |
| D90 | [nm] | 204 | 186 | 240 | 205 | 153 | 213 | 280 | 172 | 236 |
| Viscosity | [mPa · s] | 4.5 | 4.0 | 4.5 | 4.0 | 4.0 | 3.5 | 4.0 | 4.5 | 4.5 |
| (Pigment dispersion) | | | | | | | | | | |
| Preservation stability | Viscosity change rate [%] | 4.5 | 3.0 | 2.0 | 2.5 | 2.5 | 3.0 | 2.5 | 4.5 | 2.0 |
| (pigment dispersion) | Particle diameter change rate [%] | 3.0 | 4.0 | 3.0 | 3.0 | 2.0 | 2.0 | 2.0 | 3.0 | 3.0 |
| | Evaluation | A | A | A | A | A | A | A | A | A |
| Preservation stability | Viscosity change rate [%] | 4.0 | 3.0 | 4.5 | 4.5 | 4.0 | 3.5 | 4.5 | 4.0 | 4.0 |
| (ink) | Particle diameter change rate [%] | 2.0 | 3.0 | 4.0 | 4.0 | 5.0 | 1.0 | 2.0 | 4.0 | 4.0 |
| | Evaluation | A | A | A | A | A | A | A | A | A |
| Image density | Value | 1.21 | 1.17 | 1.18 | 1.17 | 1.16 | 1.18 | 1.18 | 1.16 | 1.17 |
| | Evaluation | A | A | A | A | A | A | A | A | A |
| Ejection stability | Clogging rate [% by number] | 8 | 7 | 8 | 9 | 5 | 8 | 7 | 5 | 7 |
| | Evaluation | A | A | A | A | A | A | A | A | A |

TABLE 6

| | | Compar- | Compar- | Compar- | Compar- | Compar- | Compar- | Compar- |
|---|---|---|---|---|---|---|---|---|
| | | ative | ative | ative | ative | ative | ative | ative |
| | | Example I | Example 2 | Example 3 | Example 4 | Example 5 | Example 6 | Example 7 |
| Pigment dispersion | | D-10 | D-11 | D-12 | D-13 | D-14 | D-15 | D-16 |
| Ink | | I-10 | I-11 | I-12 | I-13 | I-14 | I-15 | I-16 |
| D10 | [nm] | 78 | 58 | 55 | 96 | 83 | 87 | 91 |
| D50 | [nm] | 136 | 75 | 87 | 137 | 124 | 146 | 133 |
| D90 | [nm] | 268 | 151 | 142 | 320 | 258 | 257 | 310 |
| Viscosity | [mPa · s] | 4.0 | 4.5 | 4.5 | 4.0 | 4.5 | 7.5 | 8.0 |
| (Pigment dispersion) | | | | | | | | |
| Preservation stability | Viscosity change rate [%] | 25.0 | 2.0 | 2.0 | 25.0 | 11.0 | 26.5 | 25.0 |
| (pigment dispersion) | Particle diameter change rate [%] | 3.0 | 4.0 | 3.0 | 4.0 | 5.0 | 11.0 | 14.0 |
| | Evaluation | B | A | A | B | B | B | B |
| Preservation stability | Viscosity change rate | 11.5 | 3.5 | 4.0 | 17.0 | 19.0 | 20.0 | 18.0 |
| (ink) | Particle diameter change rate [%] | 4.0 | 4.0 | 7.0 | 9.0 | 4.0 | 6.0 | 7.0 |
| | Evaluation | B | A | B | B | B | B | B |
| Image density | Value | 1.18 | 1.07 | 1.08 | 1.19 | 1.11 | 1.20 | 1.11 |
| | Evaluation | A | B | B | A | B | A | B |
| Ejection stability | Clogging rate [% by number] | 13 | 4 | 4 | 12 | 11 | 16 | 19 |
| | Evaluation | B | A | A | B | B | B | B |

The terms in Tables 5 and 6 are defined as follows.
D10: D₁₀ of pigment particles contained in pigment dispersion
D50: D₅₀ of pigment particles contained in pigment dispersion
D90: D₉₀ of pigment particles contained in pigment dispersion
Viscosity (pigment dispersion): viscosity of pre-storage pigment dispersion
Preservation stability (pigment dispersion): evaluation of preservation stability of pigment dispersion
Preservation stability (ink): evaluation of preservation stability of ink
Clogging rate: nozzle clogging rate

With respect to the styrene-acrylic resin (R-7) contained in the pigment dispersion (D-10), the added molar number (corresponding to m₁ in formula (1)) was less than 4 as shown in Tables 1 and 2. With respect to the styrene-acrylic resin (R-8) contained in the pigment dispersion (D-11), the added molar number (corresponding to m₁ in formula (1)) was greater than 9. With respect to the styrene-acrylic resin (R-9) contained in the pigment dispersion (D-12), the added molar number (corresponding to m₁ in formula (1)) was greater than 9. The styrene-acrylic resin (R-10) contained in the pigment dispersion (D-13) did not include the first repeating unit. With respect to the styrene-acrylic resin (R-11) contained in the pigment dispersion (D-14), the first-repeating-unit percentage was greater than 10% by mass. With respect to the styrene-acrylic resin (R-12) contained in the pigment dispersion (D-15), the end group (corresponding to R² in formula (1)) was an alkyl group with a carbon number of greater than 7. With respect to the styrene-acrylic resin (R-13) contained in the pigment dispersion (D-16), the first-repeating-unit percentage was greater than 10% by mass and the end group (corresponding to R² in formula (1)) was an alkyl group with a carbon number of greater than 7. As a result, at least one of the evaluation of preservation stability of the pigment dispersions (D-10) to (D-16), the evaluation of image density of the images formed with the inks containing the respective pigment dispersions, and the evaluation of ejection stability of the inks containing the respective pigment dispersions was rated as B as shown in Table 6. As further shown in Table 6, at least one of the evaluation of preservation stability, the evaluation of image density, and the evaluation of ejection stability was rated as B for the inks (I-10) to (I-16) respectively containing the pigment dispersions (D-10) to (D-16).

By contrast, the pigment dispersions (D-1) to (D-9) each had the following features as shown in Tables 1 and 2. That is, each of the pigment dispersions (D-1) to (D-9) contained pigment particles, styrene-acrylic resin, and water. The styrene-acrylic resin (specifically, each of the styrene-acrylic resin (R-1) to (R-6)) included the first repeating unit having a group represented by formula (1) and the second repeating unit not having a group represented by formula (1). The first-repeating-unit percentage was at least 1% by mass and no greater than 10% by mass. As a result, each of the evaluation of preservation stability of the pigment dispersions (D-1) to (D-9), the evaluation of image density of the images formed with the inks containing the respective pigment dispersions, and the evaluation of ejection stability of the inks containing the respective pigment dispersions was rated as A as shown in Table 5. As further shown in Table 5, each of the evaluation of preservation stability, the evaluation of image density, and the evaluation of ejection stability was rated as A for the inks (I-1) to (I-9) respectively containing in the pigment dispersions (D-1) to (D-9).

From the above, it was demonstrated that: the pigment dispersion according to the present disclosure that encompasses the pigment dispersions (D-1) to (D-9) is excellent in preservation stability; an ink containing the pigment dispersion can be stably ejected from the recording head; and images with desired image density can be formed with the ink. It was also demonstrated that the ink according to the present disclosure that encompasses the inks (I-1) to (I-9) respectively containing the pigment dispersions (D-1) to (D-9) is excellent in preservation stability, can be stably ejected from the recording head, and can form images with desired image density.

What is claimed is:

1. A pigment dispersion for an inkjet ink, comprising:
pigment particles;
styrene-acrylic resin; and
water, wherein
the styrene-acrylic resin includes a first repeating unit having a group represented by formula (1) and a second repeating unit not having a repeating unit represented by the formula (1), and
the first repeating unit has a percentage content to a total mass of the first repeating unit and the second repeating unit of at least 1% by mass and no greater than 10% by mass, 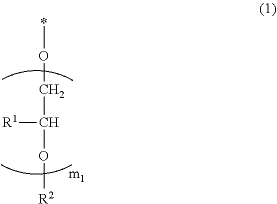
where in the formula (1), R¹ represents a hydrogen atom or a methyl group, R² represents a hydrogen atom or an alkyl group with a carbon number of at least 1 and no greater than 7, and m₁ represents an integer of at least 4 and no greater than 9.

2. The pigment dispersion according to claim 1, wherein
the first repeating unit includes a repeating unit represented by formula (2), 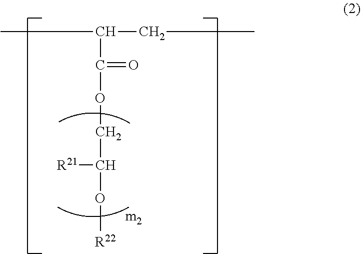
where in the formula (2), R²¹ represents a hydrogen atom or a methyl group, R²² represents a hydrogen atom or an alkyl group with a carbon number of at least 1 and no greater than 7, and m₂ represents an integer of at least 4 and no greater than 9.

3. The pigment dispersion according to claim 1, wherein
the second repeating unit includes a repeating unit represented by formula (3) and a repeating unit represented by formula (4):

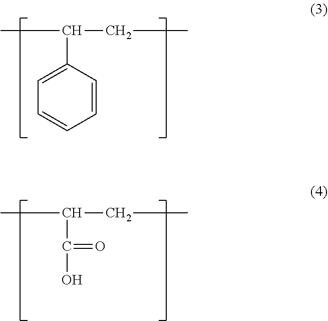

4. The pigment dispersion according to claim 1, wherein
the pigment particles have a 10% cumulative diameter in terms of volume of at least 50 nm and no greater than 80 nm,
the pigment particles have a 50% cumulative diameter in terms of volume of at least 80 nm and no greater than 130 nm, and
the pigment particles have a 90% cumulative diameter in terms of volume of at least 150 nm and no greater than 300 nm.

5. The pigment dispersion according to claim 1, wherein
the pigment particles have a number average primary particle diameter of no greater than 17 nm,
the pigment particles have a DBP oil absorption of no greater than 130 mL/100 g, and
the pigment particles have a BET specific surface area of no greater than 300 m²/g.

6. The pigment dispersion according to claim 1, wherein
a ratio of a mass of the styrene-acrylic resin to a mass of the pigment particles is at least 0.50 and no greater than 0.75.

7. The pigment dispersion according to claim 1, wherein
the styrene-acrylic resin including the first repeating unit having the group represented by the formula (1) is directly attached to surfaces of the pigment particles.

8. An inkjet ink comprising:
the pigment dispersion according to claim 1; and
a water-soluble organic solvent.
